(19) United States
(12) Patent Application Publication
(10) Pub. No.: US 2003/0152885 A1
(43) Pub. Date: Aug. 14, 2003

(54) Dental curing device with blue light emitting diodes

(76) Inventor: Viet Hung Dinh, San Diego, CA (US)

Correspondence Address: W. Edward Johansen, 11661 San Vicente Boulevard, Los Angeles, CA, 90049, US

(21) Appl. No.: 09/993,683

(22) Filed: Nov. 26, 2001

(51) Int. Cl. A61C 3/00

(52) U.S. Cl. 433/29

(57) ABSTRACT

A self-contained light source that cures a synthetic resin coating on teeth. The self-contained light source includes an elongated container that has a central longitudinal axis and also has a proximal portion and a distal portion lying along the central longitudinal axis, an attachment that is electrically and mechanically coupled to the elongated container at the distal portion. There is an array of closely spaced light emitting diodes. Each light emitting diode emits light in the blue region of the light spectrum. A power supply is disposed within the elongated container for powering the light emitting diodes. A mount is disposed in the attachment and orients the light emitting diodes to emit parallel light. A convex lens is optically coupled to the light emitting diodes. The convex lens focuses and directs the parallel light out of the attachment in a predetermined pattern.

### BACKGROUND OF THE INVENTION

This invention relates to the curing of liquid resin coatings applied to teeth to cover tooth surfaces and to fill cavities, chips and the like. The resins harden to produce a tough, hard coating when subjected to rradiation with light at predetermined wavelengths.

U.S. Pat. No. 6,102,696 teaches a self contained light source for curing light initiated resins used to coat teeth as veneers and fill cavities and chips in teeth in aesthetic or restorative procedures. The source includes an elongated container holding a battery and electronic compartment at one end and a light emitting window at the other. A plurality of closely space light emitters, typically light emitting diodes or laser diodes, are arrayed to direct light to a common focal point. The light is directed out of the container toward a tooth bearing the resin to be cured to a hard, stable state. The light emitters produce light in a region of the spectrum to which the resin curing initiators is sensitive, typically blue light. The light emitters are preferably mounted on concave edged printed circuit so that they are all oriented inwardly toward the focal point. Micro-lenses may be used with each light emitter to further concentrate light toward the focal point. A light transparent barrier sleeve is placed over the light-emitting end of the container and replaced between patients.

Since the development of light-cured resins suitable for use on tooth surfaces, a number of different devices and methods have been developed for curing the resins.

Originally, halogen lamps were used, directing the energy through a narrow steel tube or along a fused glass bundle wave-guide to the treatment site. Since the output is broadband, the lamp, tube or wave-guide must contain a blue filter to remove most of the unwanted energy outside the desired frequency band. This arrangement is large, inefficient and complex and requires connection to an AC electrical outlet. The filters tend to have short useful lives and pass some other light in addition to the desired blue light, which will tend to undesirably heat the treatment area and the lamp reflectors degrade with time.

Powerful argon ion lasers that emit at a number of discrete spectral lines have been used. These lasers are expensive, have a limited lifetime, are inefficient converters of electrical energy into blue light and generate large amounts of heat. Diode pumped crystals double the input frequency into the blue spectrum as do plasma arc tubes. These units are large, complex and expensive, requiring electrical connection to a high power source. The hand piece used to direct the energy to the treatment site tends to be large and to be restrictive and unwieldy due to the wiring to an external electrical supply. Attempts have been made to use the recently developed blue light emitting diodes, which require no filter. A plurality of light emitting diodes may be arrayed at the large end of a tapered glass member or are positioned so that each light emitting diode feeds one fiber of a fiber bundle. Unfortunately, these arrangements have considerable coupling and taper/fiber losses. There is a continuing need for light sources for use in curing resins coated on teeth that will produce a narrow band of wavelengths in the blue light region, that are simple, reliable, efficient and inexpensive, that are small, light weight and self contained with no need for external wiring.

Originally, halogen lamps were used, directing the energy through a narrow steel tube or along a fused glass bundle wave-guide to the treatment site. Since the output is broadband, the lamp, tube or wave-guide must contain a blue filter to remove most of the unwanted energy outside the desired frequency band. This arrangement is large, inefficient and complex and requires connection to an AC electrical outlet. The filters tend to have short useful lives and pass some other light in addition to the desired blue light, which will tend to undesirably heat the treatment area and the lamp reflectors degrade with time. Powerful lasers, such as argon ion lasers that emit at a number of discrete spectral lines have been used. These lasers are expensive, have a limited lifetime, are inefficient converters of electrical energy into blue light and generate large amounts of heat. Diode pumped crystals double the input frequency into the blue spectrum. These units are large, complex and expensive, requiring electrical connection to a high power source. The hand piece used to direct the energy to the treatment site tends to be large and to be restrictive and unwieldy due to the wiring to an external electrical supply.

U.S. Pat. No. 6,159,005 teaches an apparatus for photo-polymerizing synthetic materials, specifically dental materials containing camphor quinone or phosphine oxide as a photo-initiator, that includes a light source constituted by a semiconductor base solid-state radiation emitter which emits in the blue spectral range. Since the radiation emitter emits in a small useful spectral range only, any heat radiation is avoided. The overall device is formed as a small, lightweight and handy device with a built-in battery. The solid-state radiation emitter, which is operated in the light emitting diode mode, may be arranged directly on the tip of the apparatus which can be directed toward the treatment site.

U.S. Pat. No. 6,171,105 teaches blue-light polymerizing system that includes comprises a xenon arc lamp in which its sapphire window includes a blue band-pass filter coating. This eliminates any external color filters that would otherwise be necessary for the polymerization of dental composite materials in a patient's mouth. The blue band-pass filter coating causes the xenon arc lamp to heat an extra 10 degrees C. higher than would otherwise be the case. So a special anode heat sink is fitted in which the front and back halves of each radial fin have been eparated, and one of these groups of separated fins has been tilted off normal. Such changes the otherwise laminar airflow through the anode heatsink fins to a turbulent flow that is better able to collect heat and carry it off.

U.S. Pat. No. 6,282,013 teaches a system for curing polymeric materials including dental composites. Modulated light is used to control the formation of polymer chains in the polymeric material so that a cured polymeric material that has the desired physical characteristics for its intended function. Formation of short chain and long chain polymers from monomers in the polymeric material is initiated and controlled by using a light source with a wavelength suitable for one or more initiators found in the polymeric material.

U.S. Pat. No. 5,328,368 teaches a disposable elongate protective sheath for covering the tip of a dental cure light to prevent cross contamination between dental patients.

U.S. Pat. No. 5,634,711 teaches a hand-held portable light emitting device that is suitable for medical and industrial photo-curing and photo-therapy. The hand-held portable light emitting device includes a portable housing, a semi-conducting light emitter, a power supply, a controller, a mount and an optical assembly. The portable housing has a front end and a rear end. A matrix of the light emitting diodes is mounted at the front end of the housing to emit light energy suitable for initiating a photo reaction. The power supply connected to the light emitting diode to provide the electrical power for energizing the diodes to emit the light energy. The controller is connected to the light emitter and the power supply, to vary the level of the light energy. The mount is disposed at the front end of the housing. The optical assembly is mounted to the mount, to direct the light energy generated from the diodes to a photo-reaction site near the optical assembly.

U.S. Pat. No. 5,420,768 teaches a portable photo-curing device that has a light emission diodes matrix which can be energized with battery power to provide optical power for photo-curing purposes. The light emitting diodes can be easily controlled and adjusted to emit light of selected colors and intensity with complex instrumentation.

U.S. Pat. No. 6,318,996 teaches a dental composition curing device for exposing a dental composition to a beam of radiation emitted by a light-emitting-diode positioned proximate the composition. The light emitting diode radiation is more efficient than the conventional use of filtered white light or laser radiation. Certain polymeric materials useful in the field of dentistry for adhesion, sealing and restoration may be cured or hardened upon exposure to a source of radiation. Such photo-active materials are known as “photo-curable dental compositions” and generally harden when exposed to radiation having wavelengths in the visible range. Photo-cured dental compositions are convenient for use by a dentist because the curing process can be initiated when the dental composition has been accurately placed in its proper position. A source of radiation energy positioned proximate to the material to be hardened, for example an appropriate amount of composition placed inside a tooth cavity, is activated to initiate polymerization and subsequent curing of the composition to secure the repair. Photo-cured dental compositions were initially hardened by the application of concentrated beams of ultraviolet (UV) radiation. In order to provide such UV radiation, dental guns and other apparatuses for producing concentrated beams of UV radiation were developed. Later, visible light curable dental compositions were used and dental radiation guns for producing concentrated visible light were provided like that that disclosed in U.S. Pat. No. 4,385,344. However, a relatively high divergence about 25 degrees of the light beam from such visible light sources reduces penetration into the tooth structure, leading to their relative inefficiency and unreliability for photo-curing dental composition that are thicker than about two millimeters.

Photo-curable dental materials have also been developed that are hardened by exposure to radiant energy in a preselected spectral range. A photo-activated chemical reaction in many photo-curable dental materials is initiated by application of a high intensity blue light having a wavelength of 400-500 nanometers. Since the light sources employed typically produce the entire visible light spectrum as well as some non-visible radiation, a reflector is coated to reflect only visible light, and the filters are selected to substantially block non-visible radiation and visible light other than blue light in the range of 400-500 nanometers, in order to produce the desired range of radiation, as shown for example in U.S. Pat. No. 5,147,204. Laser-based radiation sources have also been employed, using for example, a Nd YAG laser producing radiation at a wavelength of about 1060 nanometers, in combination with a frequency doubling material as disclosed for example in U.S. Pat. No. 5,885,082. In the instance that a laser source is used, the beam must be de-focussed to cover the area being cured and this is done by varying by hand the distance between the dental composition and the laser dental gun.

There are several disadvantages in using light curing apparatuses of the prior art like those discussed above. Commercially available dental light guns often include an elongated, slender light guide such as a bundle of optical fibers having a free end that can be positioned close to the photo-curable material in order to direct light to the material from a light source located outside the oral cavity. Thus, because of the relatively large size of the dental gun within a patient's mouth, a degree of physical discomfort is introduced to the patient as well as to the dentist who must hold the gun steady for about one minute.

Second, the area illuminated by conventional blue-filtered metal-halide radiation is usually in the range of about a ½-inch diameter circle and over a typical curing cycle of about 60 seconds. The relatively high energy output and beam divergence of such dental guns leads to the possibility of increased heating of the pulp tissue which is sensitive to small changes in temperature.

In addition, when dental compositions are cured in place within a cavity for instance, after curing an amount of shrinkage of about 2.5% occurs leaving a gap within the area being treated; such shrinkage is so deleterious that any small reduction in shrinkage is desirable.

Furthermore, in tests of cure depth uniformity of standardized compositions, it was found that a high percentage (46%) of curing lights used in private dental offices are unsuitable for use when tested against manufacture's recommendations using a curing radiometer or a heat radiometer, due in part to the loss of output of the light source in use. Finally, due to the expenses of combining a laser or metal-halide radiation source, focussing elements and power sources, significant expense are involved in purchasing and using dental guns. Conventional dental curing devices are therefore seen to have shortcomings including uncomfortable use, unreliable curing and relatively high expense.

U.S. Pat. No. 4,385,344 teaches a dental gun device for production of light in the low visible range for photo-curing dental compositions that includes a tungsten halogen lamp with a concentrating reflector which reflects visible light and passes middle and far infrared wavelengths. A dichroic heat reflecting filter which passes light from 400 to 700 nm and reflects energy in the visible red and near infrared wavelengths back to the lamp envelope, enhances lamp halogen cycle efficiency. The dichroic heat reflecting filter is followed by a dielectric filter which provides a high efficiency band-pass at the desired visible range. A fiber optic light guide is positioned to receive the focused and filtered light and to transmit it to a reduced surface light applying tip at the end of the handpiece. The fiber light guide is encased in a specially designed sheathing which provides protection to the optical fibers and carries two electrical conductors which are connected between a control switch on the handpiece and the power supply for the lamp.

U.S. Pat. No. 5,147,204 teaches a blue light emitting apparatus for curing photo-curable dental material that includes a handpick having a housing, a depending handle and a detachable light guide. The light guide is received in a head connected to the housing. A source of tungsten-halogen light is coupled to the housing. A light guide is detachably connected to the head for communication with the source of light. Since the tungsten-halogen light produces the entire visible light spectrum as well as some non-visible radiation, a reflector is coated to generally reflect only visible light, and a blue-pass filter and a heat filter are selected to substantially block non-visible radiation and visible light other than blue light in the range of 400-500 nanometers.

U.S. Pat. No. 5,885,082 teaches the use of pulsed laser radiation having a selected wavelength for performing a variety of dental procedures, including curing and hardening of a dental composition containing hydroxyapatite and phosphoric acid. The use of laser radiation for curing employs a housing provided with an optical fiber coupled to a source of monochromatic light, such as an Nd YAG laser operating at a wavelength of 1060 nanometers. The optical fiber directs light radiation onto a curved mirror which deflects the radiation onto the receiving end of a further optical fiber. A frequency doubling material influences the laser radiation so that such a laser-based dental gun has the capability of applying either 1060 nanometers or 532 nanometers radiation to the area to be treated. It is significant that cooling water is disclosed as being sprayed onto the tooth in the vicinity of the spot which is being irradiated, especially when radiation at 532 nanometers is applied. A further disadvantage of the use of laser radiation is de-focussing the laser beam to be coextensive with the surface of filling composition by varying by hand the spacing between the laser dental gun and the tooth surface.

U.S. Pat. No. 6,077,073 teaches a sheathed, conformable, multi-tooth device for curing adhesives, sealants and/or whitening or coloring agents that is used in the dentistry field. Light emitting diode lights are connected in an array and a relatively low voltage (e.g., 5 volts) powers the light emitting diode array. The light emitting diode array is housed within a clear, transparent and/or translucent housing constructed of either a solid, such as a poured resin, or a hollow structure. The housing conforms to an approximate shape of dentition. The housing is mountable within a disposable oversertion sheath. During use, the light emitting diode array transmits light that cures the adhesives, sealants and/or whitening or coloring agents, preferably on several teeth simultaneously.

U.S. Pat. No. 5,201,655 teaches a light guide that is adapted for photo-curing. Two optical conductors are spaced to form a gap adapted to receive a tooth. This apparatus is quite bulky in design and rather frightening in appearance, especially for use in children. Furthermore, it is only adaptable to working on one tooth at a time, and hence lacks the convenience and function of a conformable multi-tooth apparatus. Additionally, without the provision of a protective barrier interposed between the apparatus and the tooth, the device is unsanitary.

U.S. Pat. No. 5,290,169 teaches an optical light guide constructed of a transparent material, such as glass, acrylic, polystyrene and/or polycarbonate. The light is reflected within the light guide and directed at a tooth not using direct exposure of the light source at the treatment site. This device is quite bulky in design. The device further is only adaptable to working on one tooth at a time, and hence lacks the convenience and function of a conformable multi-tooth apparatus. Additionally, without the provision of a protective barrier interposed between the apparatus and the tooth, the device is unsanitary.

U.S. Pat. No. 5,316,473 teaches a light-curing apparatus that includes a dental tray and a wand which either fits over the dental tray or is slidably engaged with the dental tray. The wand has a plurality of light sources which may be a series of light bulbs or a series of light emitting diodes, or which may be fiber optic element having optic fibers with ends that emit light into an impression material. This device suffers the drawback that it relies on fiber optic light, and hence is more costly than other devices. Additionally, the apparatus is not conformable to any shape mouth or for working in conjunction with the upper and lower teeth at the same time. Moreover, without the provision of a protective barrier interposed between the apparatus and the tooth, the device is unsanitary. Furthermore, a multitude of tray and wand sizes must be manufactured to fit different mouths, making the apparatus complicated and expensive.

U.S. Pat. No. 5,415,543 teaches a dental apparatus for curing actinic light curable composites, primers and adhesives. A nozzle is centered within fiber optics tube that is housed within annular conduit. There are bores or orifices distributed about fiber optic tube. Gas flows out of the bores or orifices to form a uniform blanket of inert gas adjacent an emitting end of the apparatus. The actinic light source is a visible, ultraviolet, infrared or laser light source, depending upon the type of adhesive, primer or composite to be cured. This device also suffers the drawback that it relies on fiber optic light, and hence is more costly than other devices. Additionally, the apparatus is not adaptable to working with more than one tooth at a time and is not conformable to any shape mouth for working in conjunction with more than one tooth at time. Furthermore, without the provision of a protective barrier interposed between the apparatus and the tooth, the device is not sanitary. This device involves the use of sealed inert gases, not solid state electro-optics. Thus, loss or leakage of the gases may occur over time.

U.S. Pat. No. 5,487,662 teaches a dental impression tray for photo-curable impression material that includes a light source, such as a solid state light emitter or a light emitting diode, which is contained within the dental impression tray. The light emitters are positioned at spaced intervals over body of the dental impression tray. A a bank of emitters, such as light emitting diodes, which are used to provide light to light emitters. This device has as a serious shortcoming no protective barrier interposed between the apparatus and the tooth. Hence, the device is unsanitary. Additionally, the apparatus is not conformable to any shape mouth for working in conjunction with both the upper and lower teeth at the same time. A variety of sizes must be manufactured to accommodate different mouth sizes.

U.S. Pat. No. 5,702,250 teaches a dental impression tray that has an array of solid state light emitters for curing photo-curable impression material received in a channel of the tray. The emitters, such as light emitting diodes, are positioned to emit light to the impression material. This device has as a serious shortcoming no protective barrier interposed between the apparatus and the tooth. Hence, the device is unsanitary. Additionally, the apparatus is not conformable to any shape mouth for working in conjunction with more than one tooth at a time, and does not permit light exposure simultaneously to the right and left sides of the mouth.

U.S. Pat. No. 5,711,665 teaches a device to bond orthodontic brackets to teeth. A curing light is removably received within a passage of the bracket. This device is quite bulky in design and has no protective barrier interposed between the apparatus and the tooth. Designed more for use with braces, the device is unsanitary insomuch as repeated, direct contact between the device and the mouth is expected. Additionally, the apparatus is not conformable to any shape mouth for working in conjunction with more than one tooth at a time. The key/keyhole design and use makes the method difficult to employ, requiring laborious skill in placement for each tooth.

U.S. Pat. No. 5,718,577 teaches a dental impression tray that forms a channel that receives or contains a photo-curable dental impression material. A wall or a wall portion adjacent the chamber is constructed of a material that transmits electromagnetic actinic radiation. Another chamber of the tray contains a chemical-luminescent composition that cures the photo-curable dental impression material. The device relies on a chemical reaction to produce the light used during the cure instead of direct illumination with solid state electro-optics. Additionally, the apparatus is not conformable to any shape mouth. Different sizes must be manufactured to accommodate a variety of mouth sizes. The device is most adaptable for working in conjunction with one tooth at a time. It cannot be accommodated to work on both the upper and lower teeth simultaneously. Furthermore, without the provision of a protective barrier interposed between the apparatus and the tooth, the device is unsanitary.

The inventor hereby incorporates the above-referenced patents by reference.

### SUMMARY OF INVENTION

The present invention is generally directed to a self-contained light source that cures a synthetic resin coating on teeth. The self-contained light source includes an elongated container and an attachment. The elongated container has a central longitudinal axis and also has a proximal portion and a distal portion lying along the central longitudinal axis. The attachment is electrically and mechanically coupled to the elongated container at the distal portion. There is an array of closely spaced light emitting diodes disposed within the attachment. Each of the light emitting diodes emits light in the blue region of the light spectrum. There is a power supply that is disposed within the elongated container for powering the light emitting diodes.

In a first aspect of the present invention, there is a mount and a convex lens. The mount is disposed in the attachment and orients the light emitting diodes to emit parallel light. The convex lens is optically coupled to the light emitting diodes. The convex lens focuses and directs the parallel light out of the attachment in a predetermined pattern.

In a second aspect of the present invention, there are seven light emitting diodes in the array.

In a third aspect of the present invention, the array of light emitting diodes consists of fifty light emitting diodes on a rectangular substrate.

In a fourth aspect of the present invention, the array of light emitting diodes consists of one light emitting diode.

In a fifth aspect of the present invention, the array of light emitting diodes consists of fifty light emitting diodes on a rectangular, flexible substrate that is adapted to be inserted into a patient's mouth during a whitening procedure.

In a sixth aspect of the present invention, wires to the light emitting diodes are connected by conductive epoxy.

In a seventh aspect of the present invention, the attachment is filled with a heat conductive gel that slowly conducts heat away from the array of light emitting diodes. This not only protects the light emitting diodes, but also conducts the heat slowly enough so that the heat does not burn the patient's mouth.

In an eighth aspect of the present invention, a charging-base not the only has a charging apparatus for recharging the power supply, but also a testing apparatus for testing the self-contained light source.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### BRIEF DESCRIPTION OF THE DRAWINGS

FIG. 1 is a perspective drawing of a self-contained light source that cures a synthetic resin coating on teeth and that has an elongated container, a charging base and a first attachment according to a first embodiment.

FIG. 2 is an elevation in cross-section of the first attachment of the self-contained light source of FIG. 1 wherein the first attachment has a tube, a housing, a mount, a convex lens and an array of seven light emitting diodes.

FIG. 3 is a side elevation of the mount and the seven light emitting diodes of FIG. 2.

FIG. 4 is a top plan view of one of the seven light emitting diodes of FIG. 2.

FIG. 5 is a bottom plan view of one of the seven light emitting diodes of FIG. 2.

FIG. 6 is a side elevation of the mount and the fifty light emitting diodes of a second attachment of a self-contained light source according to the second embodiment wherein the fifty light emitting diodes are disposed on a rectangular substrate.

FIG. 7 is a top plan view of the mount and the fifty light emitting diodes of FIG. 6.

FIG. 8 is a partial elevation of a third attachment of a self-contained light source according to the third embodiment.

FIG. 9 is a partial elevation in cross-section of the third attachment of FIG. 8 wherein the third attachment has a tube, a housing, a mount, a convex lens and one light emitting diode.

FIG. 10 is a partial perspective drawing of a self-contained light source that whitens teeth and that has a fourth attachment according to a fourth embodiment.

FIG. 11 is a partial elevation of the fourth attachment of FIG. 10 wherein the fourth attachment has a tube, flexible housing, a flexible mount and an array of fifty light emitting diodes.

FIG. 12 is a top plan view of the flexible mount and the array of fifty light emitting diodes of FIG. 11.

FIG. 13 is a diagram of the circuit of the first attachment of FIG. 1.

FIG. 14 is an elevation in cross-section of the first attachment of the self-contained light source of FIG. 1 wherein the tube is filled with a heat conductive gel and the housing is filled with a heat conductive paste.

FIG. 15 is a side elevation in cross-section of the handle of FIG. 1 wherein the elongated container has a battery, a DC converter and a light emitting diode controller.

FIG. 16 is a schematic drawing of the DC converter of FIG. 15.

FIG. 17 is a schematic drawing of the light emitting diode controller of FIG. 16.

FIG. 18 is a top plan view of the charging base of FIG. 1 wherein the charging base contains a charging apparatus for recharging the power supply and a testing apparatus for testing the self-contained light source. a charging circuit and a testing circuit.

FIG. 19 is an elevation of the charging base of FIG. 13.

FIG. 20 is a top plan view of the charging apparatus and the testing apparatus of FIG. 18.

### DESCRIPTION OF THE PREFERRED EMBODIMENTS

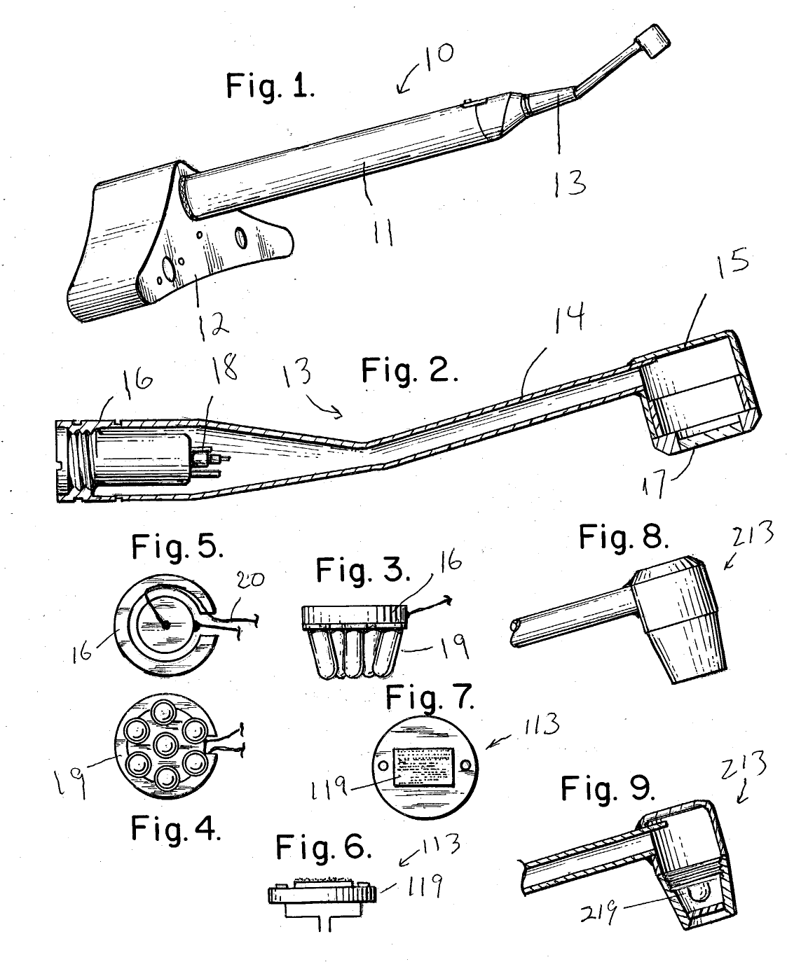

Referring to FIG. 1 a self-contained light source 10 cures a synthetic resin coating on teeth. The self-contained light source 10 includes an elongated container 11, a charging base 12 and a first attachment 13. The elongated container 11 has a central longitudinal axis and also has a proximal portion and a distal portion lying along the central longitudinal axis. The elongated container 11 inserted into the charging base 12. The first attachment 13 is electrically and mechanically coupled to the elongated container 11 at the distal portion.

Referring to FIG. 1 in conjunction with FIG. 2 the first attachment 13 includes a tube 14, a housing 15, a mount 16, a convex lens 17 and a circuit 18. The mount 16 and the convex lens 17 are disposed in the housing 15. The circuit 18 is disposed in the tube 14.

Referring to FIG. 3 in conjunction with FIG. 2 and FIG. 4 the first attachment 13 also includes an array of seven closely spaced light emitting diodes 19. Each light emitting diode 19 emits light in the blue region of the light spectrum. The mount 16 orients the light emitting diodes 19 to emit parallel light. The convex lens is optically coupled to the light emitting diodes 19. The convex lens 17 focuses the parallel light and directs it out of the first attachment 13 in a predetermined pattern.

Referring to FIG. 5 in conjunction with FIG. 2 an electrically conductive epoxy couples all seven of the light emitting diodes to a first wire 20 and to the mount 16.

Referring to FIG. 6 in conjunction with FIG. 2 and FIG. 7 a second attachment 113 includes an array of fifty light emitting diodes 119 on a rectangular substrate. Each light emitting diode 119 emits light in the blue region of the light spectrum. A mount 116 orients the light emitting diodes 119 to emit parallel light. A convex lens is optically coupled to the light emitting diodes 119. The convex lens focuses the parallel light and directs it out of the second attachment 113 in a predetermined pattern.

Referring to FIG. 8 in conjunction with FIG. 2 and FIG. 9 the third attachment 213 also includes one light emitting diode 219 which emits light in the blue region of the light spectrum. A mount 116 orients the light emitting diode 119 to emit parallel light. The convex lens is optically coupled to the light emitting diode 19. The convex lens 217 focuses the parallel light and directs it out of the third attachment 213 in a predetermined pattern.

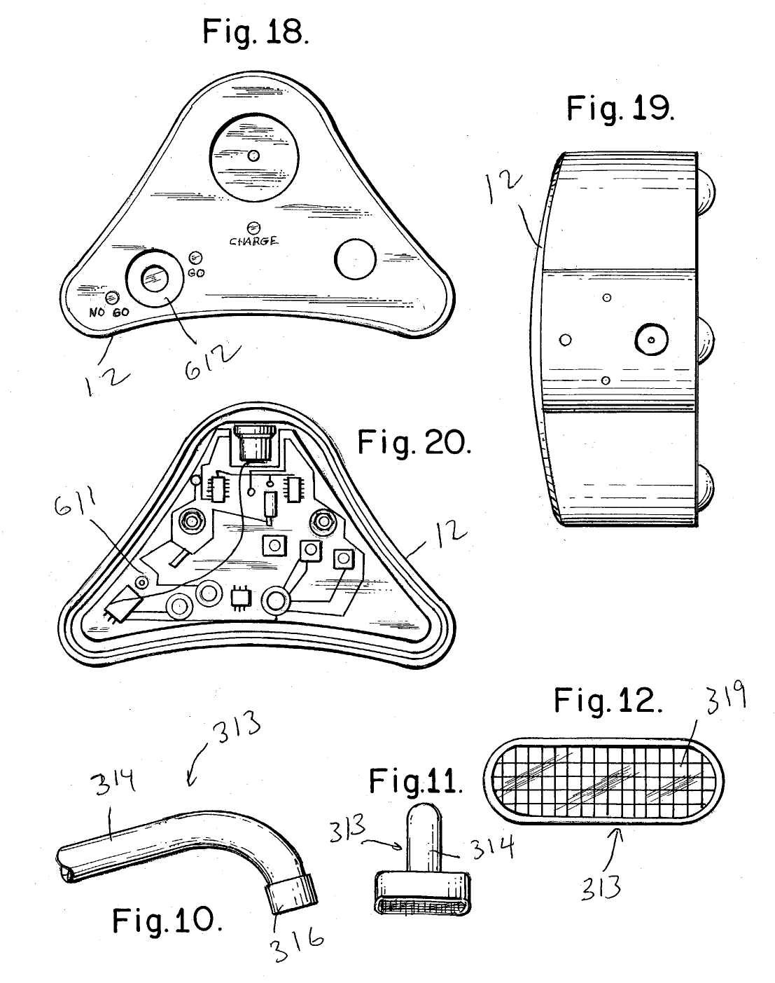

Referring to FIG. 10 in conjunction with FIG. 2 and FIG. 11 the self-contained light source whitens teeth and includes a fourth attachment 313. The fourth attachment 313 includes a tube 314, flexible housing 315, a flexible mount 316 and an array of fifty light emitting diodes 317 on a rectangular, flexible substrate. The rectangular, flexible substrate is adapted to be inserted into a patient's mouth during a whitening procedure.

Referring to FIG. 13 in conjunction with FIG. 2 circuitry of the first attachment 13 as it is disposed in the tube 14.

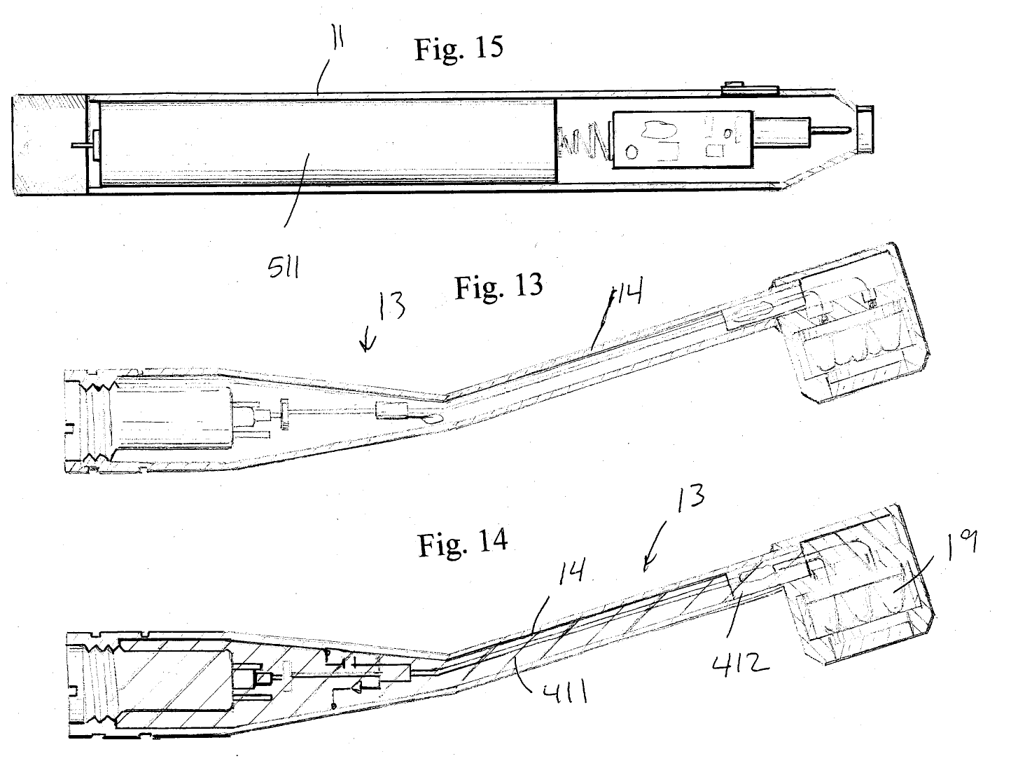

Referring to FIG. 14 in conjunction with FIG. 1 the tube 14 of the first attachment 13 is filled with a heat-conductive gel 411 and the housing 15 of the first attachment 13 is filled with a heat conductive paste 412. The heat-conductive gel and paste 411 and 412 slowly conducts heat away from the array of light emitting diodes 19. This not only protects the light emitting diodes 19, but also conducts the heat slowly enough so that the heat does not burn the patient's mouth.

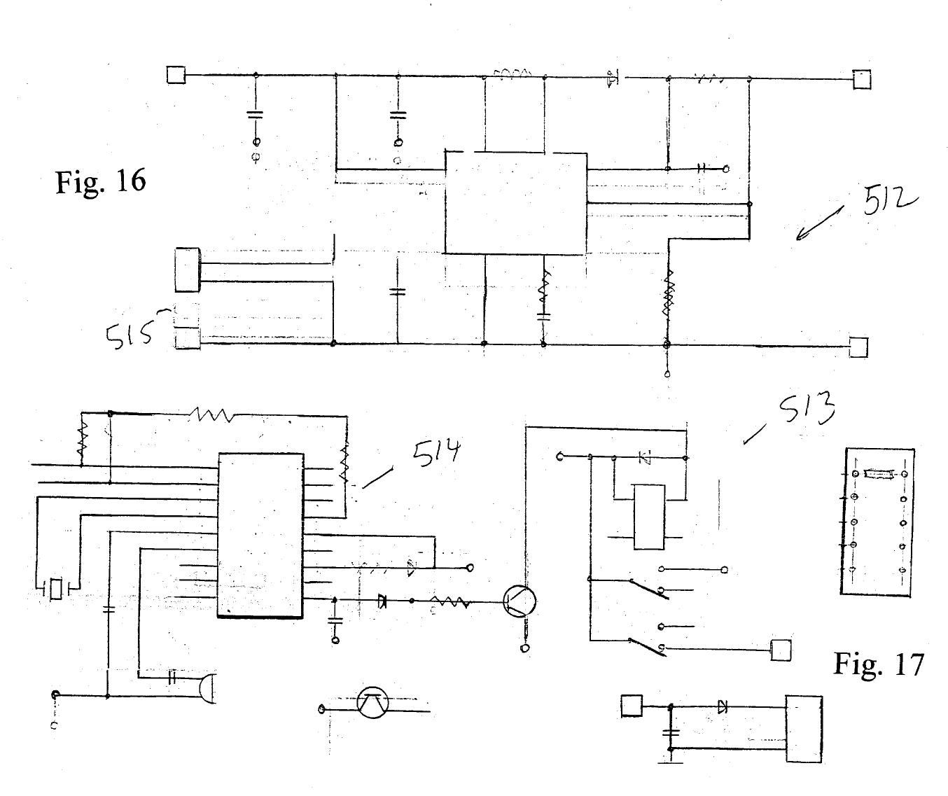

Referring to FIG. 15 in conjunction with FIG. 16 and FIG. 17 the elongated container 11 includes a battery pack 511, a charging base connector 512, a DC converter 513, a light emitting diode controller 514 and an attachment connector 515. The charging base connector 512 connects the battery pack 511 to the charging base 12. The attachment connector 515 connects the attachment 11 to the light emitting diode controller 514.

Referring to FIG. 18 in conjunction with FIG. 19 and FIG. 20 the charging base 12 contains a charging apparatus 611 for recharging the power supply and a testing apparatus 612 for testing the self-contained light source.

From the foregoing it can be seen that a self-contained light source has been described. It should be noted that the sketches are not drawn to scale and that distances of and between the figures are not to be considered significant. Accordingly it is intended that the foregoing disclosure and showing made in the drawing shall be considered only as an illustration of the principle of the present invention.

What is claimed is:

1. A self-contained light source that cures a synthetic resin coating on teeth, said self-contained light source comprising:
a. an elongated container having a central longitudinal axis and also having a proximal portion and a distal portion lying along the central longitudinal axis;
b. an attachment electrically and mechanically coupled to said elongated container at said distal portion;
b. an array of closely spaced light emitting diodes wherein each of said light emitting diodes emits light in the blue region of the light spectrum;
c. a power supply disposed within said elongated container for powering said light emitting diodes;
d. a mount disposed in said attachment wherein said mount orients said light emitting diodes to emit parallel light; and
e. a convex lens is optically coupled to said light emitting diodes wherein said convex lens focuses and directs the parallel light out of said attachment in a predetermined pattern.
